(19) United States
(12) Patent Application Publication
(10) Pub. No.: US 2010/0025947 A1
(43) Pub. Date: Feb. 4, 2010

(54) PACKING ASSEMBLY FOR THE MANUAL TRANSPORT OF PRODUCTS, AND INDUSTRIAL PLANT FOR PACKING THE SAME

(75) Inventor: Luciano Bellincampi, Frosinone (IT)

Correspondence Address: ARENT FOX LLP, 1050 CONNECTICUT AVENUE, N.W., SUITE 400, WASHINGTON, DC, 20036, US

(73) Assignee: B.R.O.S. S. R.L., Frosinone (IT)

(21) Appl. No.: 12/443,648

(22) PCT Filed: Jan. 8, 2007
(86) PCT No.: PCT/IT2007/000012

§ 371 Date: Aug. 28, 2009

(30) Foreign Application Priority Data
Sep. 29, 2006 (IT) RM2006A000515

(51) Int. Cl. B65D 71/00; B23P 19/00

(52) U.S. Cl. 280/29; 29/822

(57) ABSTRACT

The invention concerns a packing assembly for the manual transport of products, characterised in that it comprises, on a rigid plane (10), one on another in the order, wheels means (20) and one or more product units (40), the wheels (21) of the wheels means (20) remaining on the outside of the rigid plane (10), the parts of the assembly being maintained in fixed reciprocal position by vertical holding means (31,32), so that the packing assembly (100,101) be transportable on said wheels (21).

The invention further concerns a packing plant, for producing assemblies according to the invention, the plant comprising a packing line (260) upstream of which axle-wheels assemblies (20) are inletted (20), said axle-wheels assemblies (20) sliding the line (260) down to the combination with the other parts of the package; means (210) for the positioning of the plane (10) on a predetermined point of said line (260); means (270) for the temporary stopping of said plane and of said axle-wheels assemblies (20); means (240) for the positioning of the product to package on said plane (10); application means (220,280) for the application of means (31,32) of vertical holding of the package.

The present invention concerns a packing assembly for the manual transport of products, and industrial plant for packing the same.

More in detail, the present invention concerns a system which allows the packing of products so as to create packages bigger than the traditional ones and such that they can be easily transported by hand. Each package created in such a way is provided with wheels and a handle, so as it can be easily transported by hand. The invention concerns the relevant industrial plant of packing.

The traditional packing of products provides for limited dimensions of products with high specific weight, when these have to be lifted by hand for the transport (after the purchase by the consumer). For example, in the field of drinks or mineral waters the traditional packaging provides for 6 bottles of 150 cl. for an overall weight of around 9 Kg.

The disadvantages of the traditional packages lie therefore mainly in the difficulties of transport, by the consumer, of large quantities of product, both for a weight and bulk question: one can transport a water package per hand at most.

There is therefore the necessity of a packing assembly which is transportable more easily, as well as of a relevant packing plant.

It is object of the present invention a packing assembly for the manual transport which overcomes the disadvantages and solves at least part of the problems of the prior art.

It is further specific object of the present invention a packing plant for the manual transport of products, specifically devoted to the industrial production of the packing assemblies which are object of the invention.

It is subject-matter of the present invention a packing assembly for the manual transport of products, characterised in that it comprises, on a rigid plane, one on another in the order, wheels means and one or more product units, the wheels of the wheels means remaining on the outside of the rigid plane, the parts of the assembly being maintained in fixed reciprocal position by vertical holding means, so that the packing assembly be transportable on said wheels.

Preferably according to the invention, said wheels means comprise two wheels which are rotatable around a common axle.

Preferably according to the invention, said common axle comprises an internal axle to which ends the wheels are fixed and an external axle inside which the internal axle is freely rotatable.

Preferably according to the invention, said common axle is positioned so as to be close to an end of the plane.

Preferably according to the invention, the rigid plane presents the form of a quadrilateral.

Preferably according to the invention, said holding means are one or more straps.

Preferably according to the invention, said holding means is a thermoretractable film.

Preferably according to the invention, said wheels have a diameter comprised between 5 and 15 cm.

Preferably according to the invention, said wheels have a diameter comprised between 8 and 12 cm.

Preferably according to the invention, the assembly further comprises manual seizing means placed at the upper end of said one or more product units.

Preferably according to the invention, said manual seizing means are provided directly on said one or more product units.

Preferably according to the invention, said manual seizing means are constituted by a pre-perforated handle.

Preferably according to the invention, said manual seizing means are constituted by a plastic or paper board applied with adhesive tape.

It is further independent subject-matter a packing plant, for producing assemblies according to the invention, characterised in that it comprises in combination:
a packing line upstream of which axle-wheels assemblies are inletted, said axle-wheels assemblies sliding the line down to the combination with the other parts of the package;
means for the positioning of the plane on a predetermined point of said line;
means for the temporary stopping of said plane and of said axle-wheels assemblies;
means for the positioning of the product to package on said plane;
application means for the application of means of vertical holding of the package.

Preferably according to the invention, said application means for the application of means of package vertical holding are constituted by a strapping machine.

Preferably according to the invention, said application means are constituted by a oven for a thermoretractable means as means of package vertical holding.

Preferably according to the invention, the plant further comprises means for the regulation of the stream of the axle-wheels assemblies in the packing region.

Preferably according to the invention, said means for the regulation of the stream of the axle-wheels assemblies are constituted by a toothed wheel.

Preferably according to the invention, said upstream line, where the axle-wheels assemblies are inletted, is inclined upwards so that said axle-wheels assemblies slide on the line by gravity.

The invention will be now be described by way of illustration and not by way of limitation, with particular reference to the figures of the enclosed drawings, where:

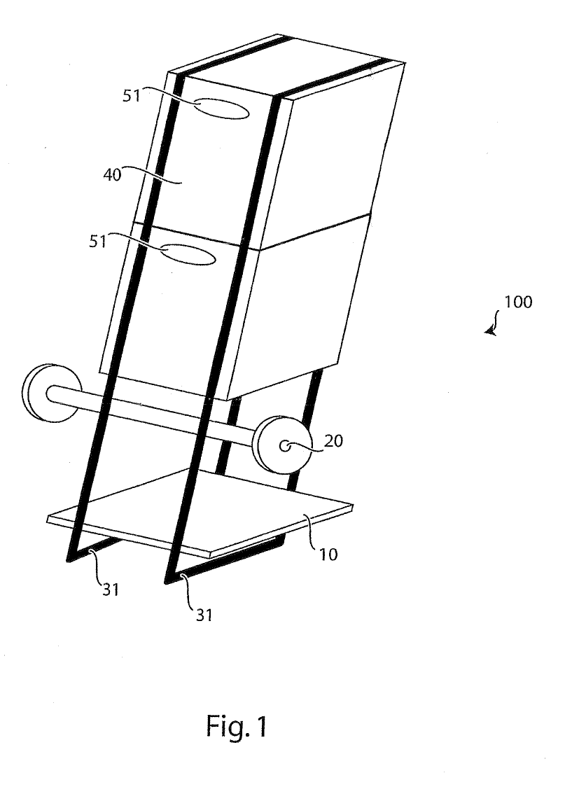

FIG. 1 shows a first embodiment of the system according to the invention;

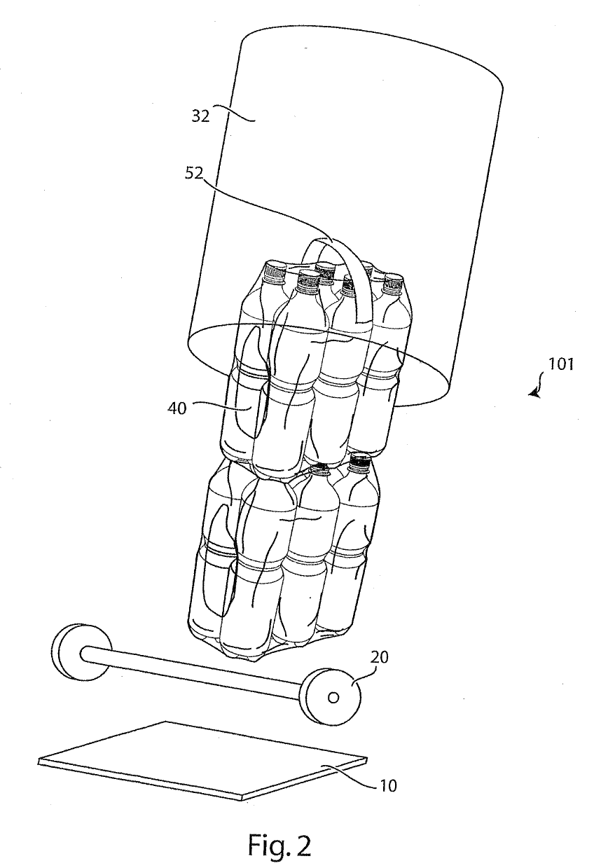

FIG. 2 shows a second embodiment of the system according to the invention;

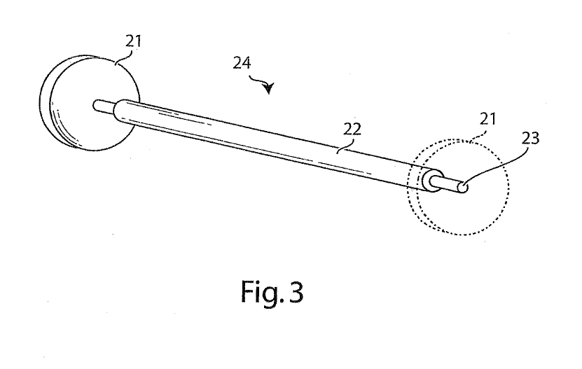

FIG. 3 shows a common detail of the embodiments of FIGS. 1 and 2;

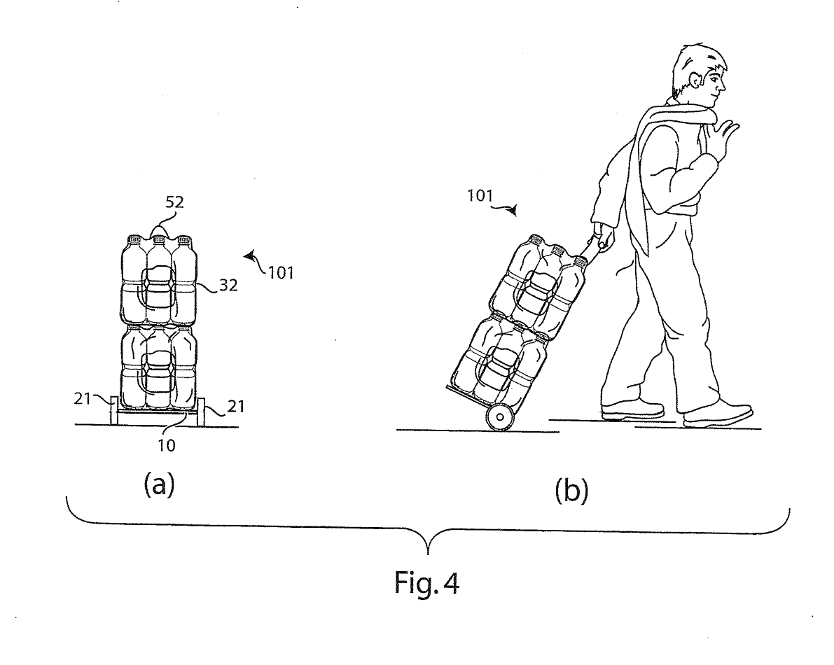

FIG. 4 shows the embodiment of FIG. 1 not in use (a) and in use (b);

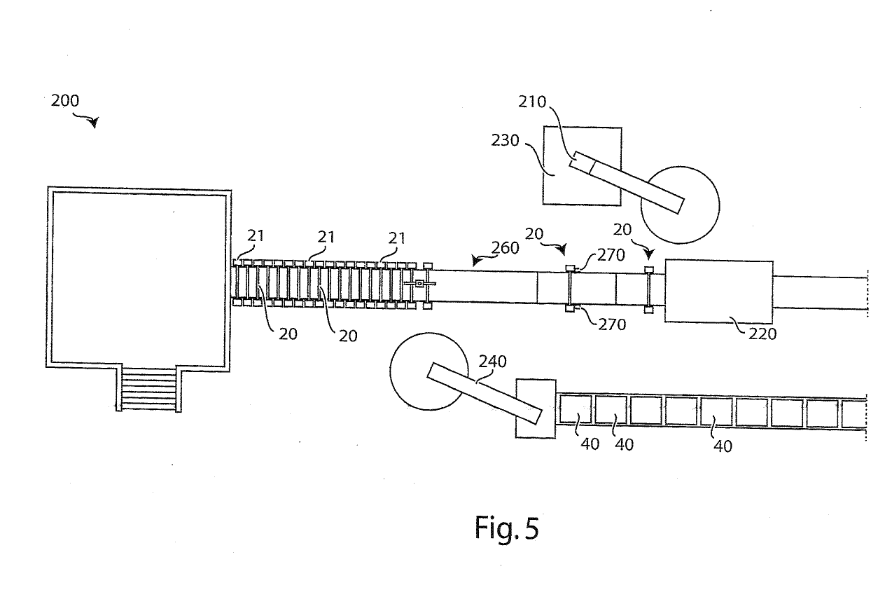

FIG. 5 shows a simplified diagram, not on scale, of a top view of an example of packaging line corresponding to the process according to the invention;

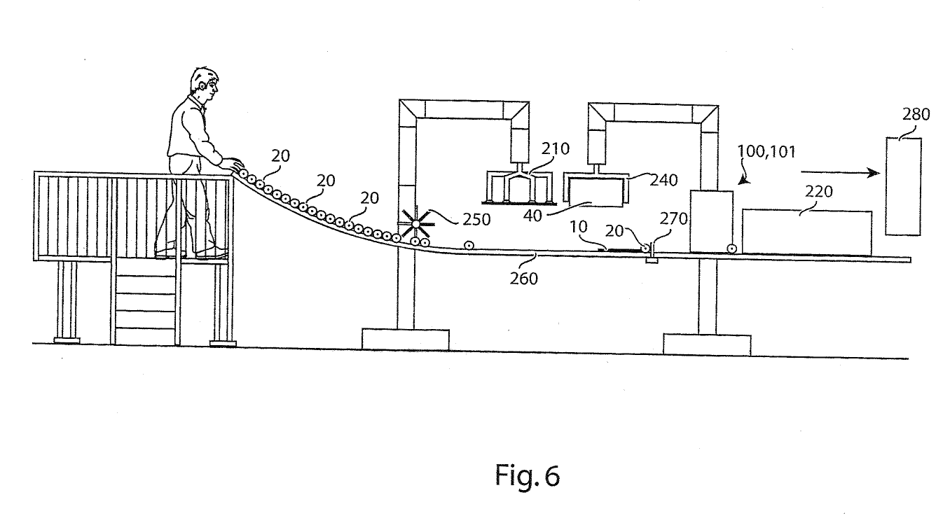

FIG. 6 shows a diagram, not on scale, of a longitudinal view of the packaging line according to FIG. 5.

### DETAILED DESCRIPTION OF THE EMBODIMENTS

Making reference to FIGS. 1 and 2, according to a first aspect of the invention, the packaging system 100,101 for the transport by hand comprises a rigid plane 10, an assembly 20 of two wheels mounted at the ends of a coaxial axle, means 31,32 of holding of the whole product 40, assembly 20 and rigid plane 10, the means being straps 31 (FIG. 1) or a cap 32 of thermoretractable film.

There are further provided manual seizing means 51, 52, which can be in particular pre-perforated handles 51 or handles of plastic or paper board applied by an adhesive tape 52, in order to seize from the top the whole package and drag it on the small wheels. The wheels-axle assembly 20 is shown more in detail in FIG. 3, from which it is clear that the two wheels 21 are fixed to the two ends of the internal axle 23 of the coaxial axle 24, whilst the rigid plane 10 (not shown) will be made integral to the external cylinder 22 of the coaxial axle 24 thanks to the above packaging.

In FIG. 4 an example is shown of the product packed thanks to the system according to the invention, standing (a) and during transport (b), and it is therefore clear that a great advantage of the system according to the invention is for example the fact that one can put one above the other two standard packs of bottles and transport them without effort.

In the following, the packed product and in general the system according to the invention will be called “roll-bag”.

Making reference to FIGS. 5 e 6, according to an aspect of the invention, the roll-bag is realised directly in the production line.

To this end, one provides for the use of the following equipment of easy commercial finding:
a suction seizing head 210 with air vacuum (the so-called “spider”) for the handling of the paperboard planes 10 which are taken out from a proper store house 230;
a programmable robot arm 240, that takes from the line the packages of product 40 to be assembled into roll-bag;
a strapping machine 220;
an applicator 280 of the stocking of retractable film, with in-line oven.

The steps of realisation are the following.

From the usual packaging line, the products are stopped on a waiting belt (not shown) controlled by photocell of overflow and underflow; if they are bundles they already have the handle 52, if they are boxes they have the pre-perforated cut 51.

The spider 210 with suckers takes out from the store house paperboards 230, a plane 10 and put it down on a not very far second belt 260, that is controlled, in the logic of start/stop, by photocells of product presence as well. Such a second belt is on slight slope, in order to enable the rolling of the assemblies wheels-axle 20 as described to the next paragraph.

The assemblies wheels-axle 20 are used just as they are, commissioning the production in outsourcing to specialised producers equipped with special press. The assemblies are stocked on a “U” double guide (truck) where house only the wheels, slightly inclined, that leads to the second belt 260 inclined as well; a toothed wheel 250 or a wheel provided with wings (which contrast the coaxial axle 24) blocks the downward motion of the axle-wheels 20 stock house; when the photocell of plane presence is crossed, the toothed wheel 250 moves of a step causing one and only one wheels-axle assembly 20 to going down towards the belt 260; the wheels-axle assembly 20 will stop on the paperboard plane 10 in a precise point determined by stops 270 placed outside the space occupied by the plane 10 and that contrast both wheels 21 impeding the rolling besides the established limit. The raising and lowering of such stops is regulated by the photocells of product presence.

The head of the robot arm 240 takes out from the waiting belt, one at a time, the packages 40 needed to realise the roll-bag and places them (one above the other) on the second belt 260 over the plane 10 and over the axle-wheels assembly 20.

The photocells of presence detects whether the number of packages put one on the other is the predetermined one and, in the positive, they cause the stops 270 to lower and give the start to the belt 260 for the completion of the roll-bag.

According to the particular type of desired roll-bag 100,101, it is used:
the applicator 280 with a oven 32 for thermoretractable film;
the strapping machine 220;
both ones.

However, in the case of utilisation of thermoretractable film 32, the performing of a cut of the thermoretracted film will be needed in the region of the wheels 21 in order to free them. Indeed, they remains incorporated in the thermoretracted film, which obviously has to wrap the bottom part of the package as well.

Such cutting operation can be made by the final user, thus maintaining a greater integrity of the roll-bag 100,101 during all the operations of handling and transportation which precede the use.

At the exit of the strapping machine 220 or the oven 260, the roll-bag is completed and can be directed to the palletizer, thus continuing the original line of packaging.

From the foregoing, it is evident the simplicity of packaging allowed by the process according to the invention, as well as the allowed volume of the individual packages and the ease of transportation of the final package.

The costs of such a process and system are almost negligible in the context of the great distribution.

The preferred embodiments have been above described and some modifications of this invention have been suggested, but it should be understood that those skilled in the art can make variations and changes, without so departing from the related scope of protection, as defined by the following claims.

1. Packing assembly for the manual transport of products, characterised in that it comprises, on a rigid plane, one on another in the order, wheels means and one or more product units, the wheels of the wheels means remaining on the outside of the rigid plane, the parts of the assembly being maintained in fixed reciprocal position by vertical holding means, so that the packing assembly be transportable on said wheels.

2. Assembly according to claim 1, characterised in that said wheels means comprise two wheels which are rotatable around a common axle.

3. Assembly according to claim 2, characterised in that said common axle comprises an internal axle to which ends the wheels are fixed and an external axle inside which the internal axle is freely rotatable.

4. Assembly according to claim 2, characterised in that said common axle is positioned so as to be close to an end of the plane.

5. Assembly according to claim 1, characterised in that the rigid plane presents the form of a quadrilateral.

6. Assembly according to claim 1, characterised in that said holding means are one or more straps.

7. Assembly according to claim 1, characterised in that said holding means is a thermoretractable film.

8. Assembly according to claim 1, characterised in that said wheels have a diameter comprised between 5 and 15 cm.

9. Assembly according to claim 8, characterised in that said wheels have a diameter comprised between 8 and 12 cm.

10. Assembly according to claim 1, characterised in that it further comprises manual seizing means placed at the upper end of said one or more product units.

11. Assembly according to claim 10, characterised in that said manual seizing means are provided directly on said one or more product units.

12. Assembly according to claim 11, characterised in that said manual seizing means are constituted by a pre-perforated handle.

13. Assembly according to claim 11, characterised in that said manual seizing means are constituted by a plastic or paper board applied with adhesive tape.

14. Packing plant, for producing assemblies as defined in claim 1, characterised in that it comprises in combination:
a packing line upstream of which axle-wheels assemblies are inletted, said axle-wheels assemblies sliding the line down to the combination with the other parts of the package;
means for the positioning of the plane on a predetermined point of said line;
means for the temporary stopping of said plane and of said axle-wheels assemblies;
means for the positioning of the product to package on said plane;
application means for the application of means of vertical holding of the package.

15. Packing plant according to claim 14, characterised in that said application means for the application of means of package vertical holding are constituted by a strapping machine.

16. Packing plant according to claim 14, characterised in that said application means are constituted by a oven for a thermoretractable means as means of package vertical holding.

17. Packing plant according to claim 14, characterised in that it further comprises means for the regulation of the stream of the axle-wheels assemblies in the packing region.

18. Packing plant according to claim 17, characterised in that said means for the regulation of the stream of the axle-wheels assemblies are constituted by a toothed wheel.

19. Packing plant according to claim 14, characterised in that said upstream line, where the axle-wheels assemblies are inletted, is inclined upwards so that said axle-wheels assemblies slide on the line by gravity.
